(19) United States
(12) Patent Application Publication
(10) Pub. No.: US 2014/0198400 A1
(43) Pub. Date: Jul. 17, 2014

(54) LIGHT COLLECTOR AND LIGHT COLLECTION MODULE

(71) Applicant: INDUSTRIAL TECHNOLOGY RESEARCH INSTITUTE, Chu-Tung (TW)

(72) Inventors: Hui-Hsiung LIN, Toufen Township (TW); Luan-Ying CHEN, Beidou Township (TW); Wen-Hsun YANG, Taipei City (TW)

(73) Assignee: INDUSTRIAL TECHNOLOGY RESEARCH INSTITUTE, Chu-Tung (TW)

(21) Appl. No.: 14/142,053

(22) Filed: Dec. 27, 2013

(30) Foreign Application Priority Data
Jan. 11, 2013 (TW) 102101198

(51) Int. Cl. G02B 7/183

(52) U.S. Cl. CPC G02B 7/183
USPC 359/853

(57) ABSTRACT

A light collector of a light concentration module includes a first surface, a second surface and at least one light emitting surface. The first surface has multiple microstructures. The microstructures are used for receiving a ray. The second surface is opposite to the first surface. The at least one light emitting surface is adjacent to the first surface and the second surface. The at least one light emitting surface forms a first angle θ with the first surface or the second surface, so as to output the rays received by the microstructures. The light collector satisfies 10°≦θ≦35° or 85°≦θ<90°.

### CROSS-REFERENCE TO RELATED APPLICATIONS

This non-provisional application claims priority under 35 U.S.C. §119(a) on Patent Application No(s). 102101198 filed in Taiwan, R.O.C. on Jan. 11, 2013, the entire contents of which are hereby incorporated by reference.

### TECHNICAL FIELD

The disclosure relates to a light collector and a light collection module.

### BACKGROUND

In recent years, with the consumption of earth's resources and the advance of science and technology, research and development on renewable energy has received more and more attention. Sunlight is inexhaustible, so governments and enterprises in the world have invested heavily in the development of solar power generation.

In solar cell systems, it is most common to receive sunlight irradiation in a fixed angle. An angle of sunlight incident on a solar cell system changes with time as well as the longitude and latitude of the deployment position of the solar cell systems, and in a fixed-type solar cell system, a frame cannot face the direction of the sun as the direction of the sun changes, so that sunlight irradiation received by the solar cell system decreases, thereby decreasing the power generation amount.

Therefore, in order to increase the sunlight irradiation received by the solar cell system, persons in the art propose a sun-tracking solar cell system formed by combining a tracking module and a solar cell module. The tracking module mainly comprises a light sensor and an electromechanical servomechanism. The sensor is used for sensing position change of the sun, so that the electromechanical servomechanism adjusts the solar cell system to face the sun, so as to increase sunlight radiation received by the solar module. It should be noted that a direction in which the sensor is mounted shall be precisely parallel to the vertical direction of the solar cell system. Furthermore, the sensor is directly exposed to an external environment, and is likely to be subject to interference and damage, so that in order to prevent the sensor from failing to sense the correct position of the sun, regular maintenance is required, which dramatically increases cost of using the solar cell system. Further, the overall volume of the sun-tracking solar cell system is large, thereby bringing inconvenience to installation.

### SUMMARY

An embodiment of the disclosure provides a light collector comprising a first surface, a second surface and at least one light emitting surface. The first surface has a plurality of microstructures. The microstructures are used for receiving a ray. The second surface is opposite to the first surface. The at least one light emitting surface is adjacent to the first surface and the second surface. The at least one light emitting surface forms a first angle θ with the first surface or the second surface, so as to output the rays received by the plurality of microstructures. The light collector satisfies 10°≦θ≦35° or 85°≦θ<90°.

Another embodiment of the disclosure provides a light collection module comprising a light collector and at least one energy conversion material. The light collector comprises a first surface, a second surface and at least one light emitting surface. The first surface has a plurality of microstructures. The plurality of microstructures are used for receiving a ray. The second surface is opposite to the first surface. The at least one light emitting surface is adjacent to the first surface and the second surface. The at least one light emitting surface forms a first angle θ with the first surface or the second surface. The light collection module satisfies 10°≦θ≦35° or 85°≦θ<90°. The at least one energy conversion material is arranged on the light collector. The at least one energy conversion material is used for converting the ray from the light collector into electric energy.

### BRIEF DESCRIPTION OF THE DRAWINGS

The disclosure will become more fully understood from the detailed description given herein below for illustration only and thus does not limit the disclosure, wherein:

FIG. 1A is a schematic perspective view of a light collection module according to a first embodiment of the disclosure;

FIG. 1B is a schematic top view of a light collection module according to a first embodiment of the disclosure;

FIG. 2A is a schematic sectional view of the light collection module in FIG. 1A according to an embodiment of the disclosure;

FIG. 2B is a schematic sectional view of the light collection module in FIG. 1A according to an embodiment of the disclosure;

FIG. 3A is a schematic top view of the light collection module in FIG. 1A according to an embodiment of the disclosure;

FIGS. 3B to 3G are respectively enlarged top views of arrangements of microstructures in FIG. 3A according to some embodiments of the disclosure;

FIG. 4 is a graph of the light collection efficiency of the light collection module in FIG. 2A having a first angle being 90 degrees regarding rays in different incident directions;

FIG. 5A is a graph of the light collection efficiency of the light collection module in FIG. 2A regarding a horizontal incident angle of rays being 0 degree when second angles between a lit surface and a normal line are 0 degrees, 5 degrees, and 40 degrees, and a third angle between a non-lit surface and the normal line is 80 degrees;

FIG. 5B is a graph of the light collection efficiency of the light collection module in FIG. 2A regarding a horizontal incident angle of rays being 90 degrees when second angles between a lit surface and a normal line are 0 degrees, 5 degrees, and 40 degrees, and a third angle between a non-lit surface and the normal line is 80 degrees;

FIG. 6A is a graph of the light collection efficiency of the light collection module in FIG. 2A regarding a horizontal incident angle of rays being 0 degree when third angles between a non-lit surface and a normal line are 70 degrees, 80 degrees, and 89 degrees, and a second angle between a lit surface and the normal line is 5 degrees;

FIG. 6B is a graph of the light collection efficiency of the light collection module in FIG. 2A regarding a horizontal incident angle of rays being 90 degrees when third angles between a non-lit surface and a normal line are 70 degrees, 80 degrees, and 89 degrees, and a second angle between a lit surface and the normal line is 5 degrees;

FIG. 7 is a graph of the light collection efficiency of the single-dimensional light collection module in FIG. 2A in which a light emitting surface and a first surface form different first angles;

FIG. 8A is a schematic sectional view of the light collection module in FIG. 1A according to an embodiment of the disclosure;

FIG. 8B is a schematic sectional view of the light collection module in FIG. 1A according to an embodiment of the disclosure;

FIG. 8C is a schematic sectional view of the light collection module in FIG. 1A according to an embodiment of the disclosure;

FIG. 8D is a schematic sectional view of the light collection module in FIG. 1A according to an embodiment of the disclosure;

FIG. 9 is a graph of the light collection efficiency of the single-dimensional light collection module in FIGS. 8A, 8B and 8D in which a light emitting surface and a first surface form different first angles being 85 degrees;

FIG. 10A is a graph of the light collection efficiency regarding different proportions of area of a first surface of the light collection module in FIG. 8D occupied by microstructures when a horizontal incident angle of rays being 0 degree.

FIG. 10B is a graph of the light collection efficiency regarding different proportions of an area of a first surface of a light collector in FIG. 8D occupied by microstructures when a horizontal incident angle of rays being 90 degree.

FIG. 11 is a schematic structural top view of a light collection module according to a second embodiment of the disclosure;

FIG. 12A is a schematic sectional view of the light collection module in FIG. 11 according to an embodiment of the disclosure;

FIG. 12B is a schematic sectional view of the light collection module in FIG. 11 according to an embodiment of the disclosure; and

FIG. 12C is a schematic sectional view of the light collection module in FIG. 11 according to an embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In this and some other embodiments, a light collection module provided by the disclosure comprises a light collector and a plurality of energy conversion materials or an energy conversion material in the shape of an annular band. The light collector comprises a first surface and a second surface opposite to each other. In this and some other embodiments, the light collector comprises a plurality of light emitting surfaces or a light emitting surface in the shape of an annular band. The number of the energy conversion materials, the number of the light emitting surfaces are adjusted according to actual needs. Moreover, whether the energy conversion material and the light emitting surface completely surround the first surface or not are also adjusted according to actual needs.

When the periphery of the light collector is round, in this and some other embodiments, the number of the energy conversion materials and the number of the light emitting surfaces are 1, and the energy conversion material and the light emitting surface are in the shape of an annular band, but not limited to the disclosure.

When the periphery of the light collector is an N-sided polygon, in this and some other embodiments, the number of the energy conversion materials and the number of the light emitting surfaces are, N, and N≧3, but not limited to the disclosure.

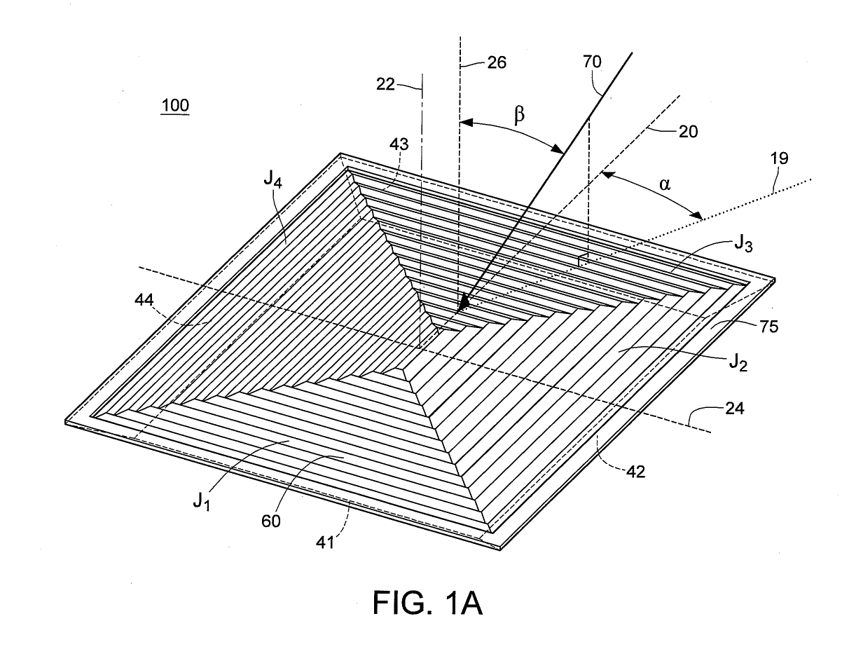

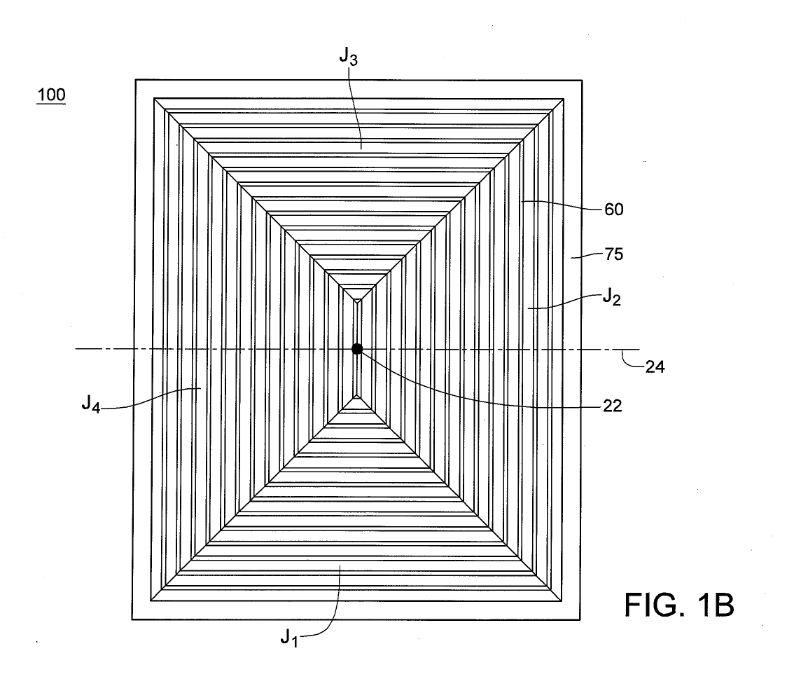

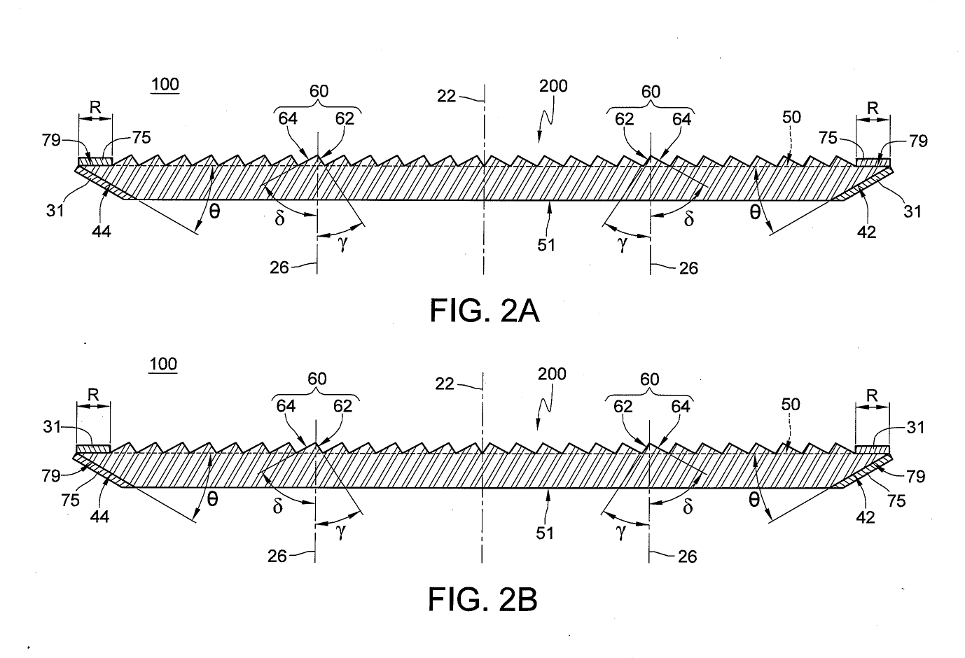

For example, the number of the light emitting surfaces is 4 and the number of the energy conversion materials is 4. Referring to FIG. 1A, FIG. 1B, and FIG. 2A, FIG. 1A is a schematic perspective view of a light collection module according to a first embodiment of the disclosure. FIG. 1B is a schematic top view of a light collection module according to a first embodiment of the disclosure. FIG. 2A is a schematic sectional view of the light collection module in FIG. 1A according to an embodiment of the disclosure. In this embodiment, a light collection module 100 comprises a light collector 200 and four energy conversion materials 31. The periphery of the light collection module 100 is a quadrangle.

The light collector 200 comprises light emitting surfaces 41, 42, 43, and 44, and a first surface 50 and a second surface 51. The first surface 50 and the second surface 51 are opposite to each other. The light emitting surfaces 41, 42, 43, and 44 are adjacent to the first surface 50 and the second surface 51. In this and some other embodiments, each of the light emitting surfaces 41, 42, 43, and 44 forms a first angle θ with the first surface 50. In this and some other embodiments, the first angle θ satisfies 10°≦θ≦35° or 85°≦θ<90°. In this and some other embodiments, a material of the light collector 200 is polymethylmethacrylate (PMMA), but the material is not limited to the disclosure.

The first surface 50 has a plurality of microstructures 60. Each microstructure 60 is used for receiving rays 70 of different incident directions, and transmitting the rays 70 to the light emitting surfaces 41, 42, 43, and 44. In this and some other embodiments, the four energy conversion materials 31 are arranged at the light emitting surfaces 41, 42, 43, and 44 respectively, so as to convert the rays 70 from the light collection module 100 into electric energy.

In this and some other embodiments, each microstructure 60 comprises a lit surface 62 and a non-lit surface 64. Each lit surface 62 is used for receiving the rays 70. The lit surface 62 and a normal line 26 of the first surface 50 form a second angle γ. The non-lit surface 64 and the normal line 26 form a third angle δ. The second angles γ and the third angle δ satisfy the following conditions:

0°≦γ≦40°; and

70°≦δ<90°.

The first surface 50 includes a central axis 22, a geometric center and a symmetry axis 24, and Each lit surface 62 faces the central axis 22 of the first surface 50, so that the rays 70 incident on the first surface 50 are transmitted to the light emitting surfaces 41, 42, 43, and 44 which surround the first surface 50. The central axis 22 is located at the geometric center of the first surface 50, and is perpendicular to the first surface 50. The microstructures 60 of the first surface 50 are symmetrically arranged on the first surface 50 according to the symmetry axis 24 of the first surface 50, so that the microstructures 60 are used for receiving the rays 70 of different incident directions.

In this embodiment, the light collector 200 further has a reflective surface 79. In an embodiment, the reflective surface 79 is arranged in a region being, but not limited to, an edge region R of the first surface 50, as shown in FIG. 2A. In this and some other embodiments, a reflective surface 75 is arranged at the reflective surface 79, so as to reflect the rays 70 received by the microstructures 60 to the four energy conversion materials 31 of the light emitting surfaces 41, 42, 43, and 44. In one embodiment, the reflective surface 79 is arranged at the light emitting surfaces 41, 42, 43, and 44, as shown in FIG. 2B. In this and some other embodiments, the reflective surface 75 is arranged at the reflective surface 79, so as to reflect the rays 70 received by the microstructures 60 to the four energy conversion materials 31 arranged in the edge region R of the first surface 50.

In one embodiment, the first surface 50 has, four light collection regions being J₁, J₂, J₃, and J₄, respectively, but the number is not limited to the disclosure. Arrangement directions of the microstructures 60 in the light collection regions J₁, J₂, J₃, and J₄ are different from each other, as shown in FIG. 1B.

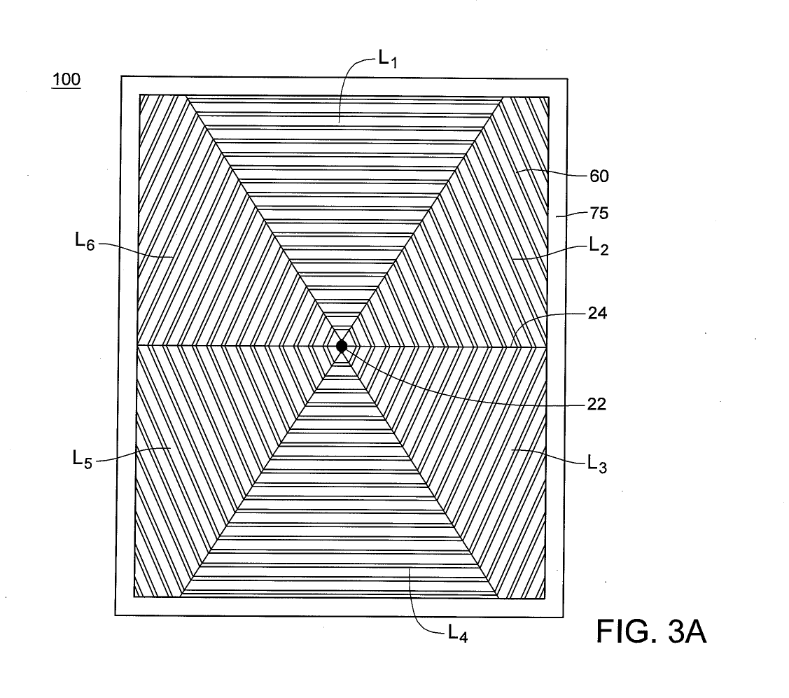

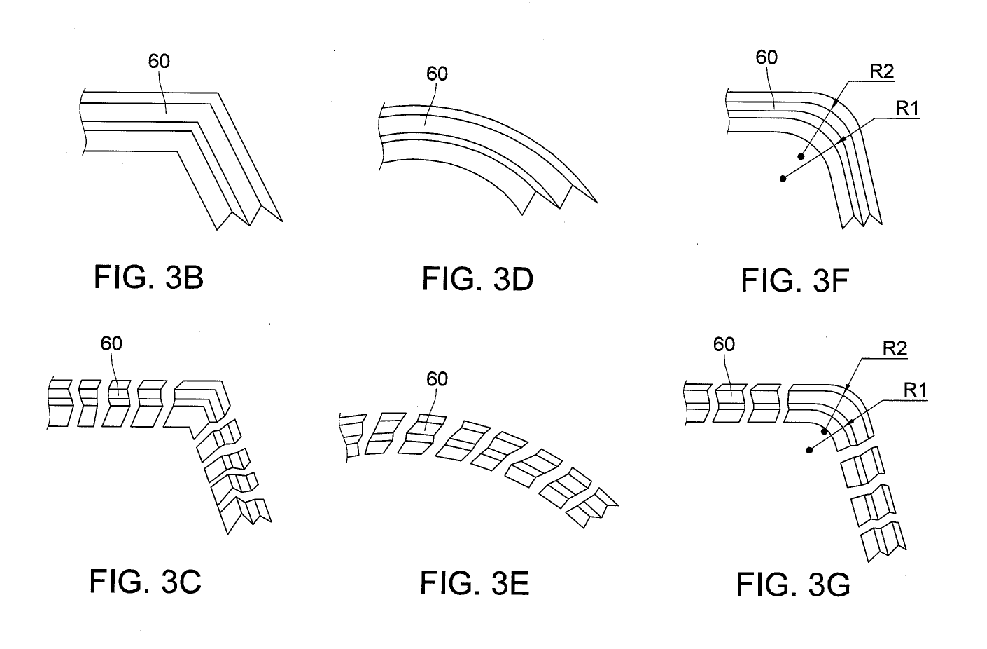

In one embodiment, the first surface 50 has six light collection regions being L₁, L₂, L₃, L₄, L₅, and L₆, respectively, but not the number is not limited to the disclosure, as shown in FIG. 3A, which is a schematic top view of the light collection module in FIG. 1A according to an embodiment of the disclosure. Arrangement directions of the microstructures 60 in the light collection regions L₁, L₂, L₃, L₄, L₅, and L₆ are different from each other. In another embodiment, the first surface 50 has more than six light collection regions.

In this and some other embodiments, the microstructures 60 is a bent stripe-shaped structure, as shown in FIG. 3B. In other embodiments, the microstructures 60 is an arc stripe-shaped structure, as shown in FIG. 3D, which is an enlarged top view of an arrangement of microstructures in FIG. 3A according to an embodiment of the disclosure. In other embodiments, the microstructures 60 is a striped structure including arc lines and straight lines, as shown in FIG. 3F, which is an enlarged top view of an arrangement of microstructures in FIG. 3A according to an embodiment of the disclosure. Referring to FIG. 3F, the radii of curvature of the two of the microstructures 60 adjacent to each other are different from each other. Otherwise, the radii of curvature of the two of the microstructures 60 adjacent to each other are the same as a specific value. The specific radius of curvature is adjusted according to the number of the light collection regions. The more the light collection regions are, the greater the radius of curvature is.

In one embodiment, the microstructures 60 are formed by a plurality of segments which are discontinuously arranged. These segments are arranged into a broken line structure, as shown in FIG. 3C, which is an enlarged top view of an arrangement of microstructures in FIG. 3A according to an embodiment of the disclosure. In other embodiments, these segments are a stripe-shaped structure including curved lines and straight lines, as shown in FIG. 3G, which is an enlarged top view of an arrangement of microstructures in FIG. 3A according to an embodiment of the disclosure. Referring to FIG. 3G, the radii of curvature of the microstructures 60 adjacent to each other are different from each other, or the same as a specific value. The specific radius of curvature is adjusted according to the number of the light collection regions. When the number of the light collection regions of the first surface 50 is increased, the shape of the microstructures is closer to arc, and the radius of curvature is increased accordingly, too.

In this and some other embodiments, the microstructures 60 are arranged in a closed loop or an open loop according to actual requirement.

The above-mentioned edge region R is the periphery of the first surface 50. FIGS. 2A and 2B are schematic sectional view of the light collection module in FIG. 1A according to an embodiment of the disclosure, in this and some other embodiments, the edge region R is two line segments in FIGS. 2A and 2B. A horizontal projection direction 19 of the ray 70 and a reference axis 20 form a horizontal incident angle α. The incident direction of the ray 70 and the normal line 26 form an incident tilt angle β. The reference axis 20 is perpendicular to the arrangement direction of the microstructures 60 in the light collection region J₃.

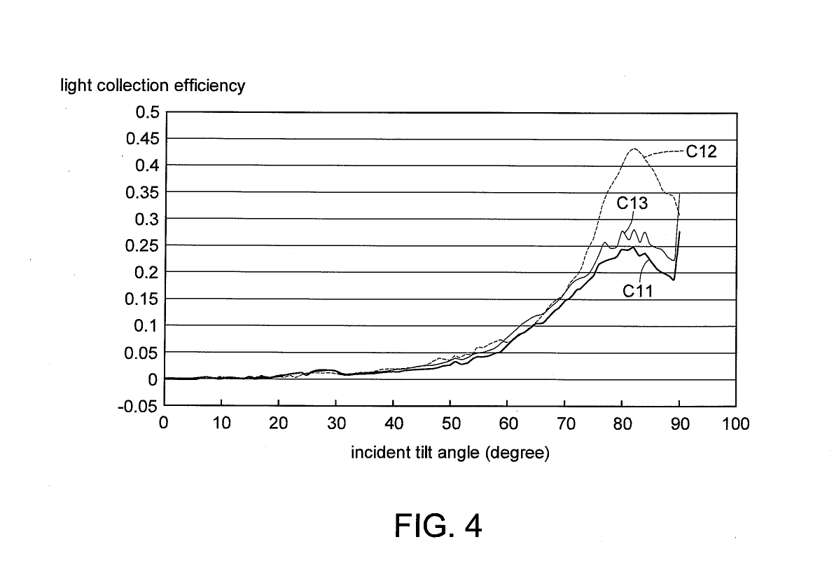

An experiment is performed below by using the light collection module 100 in FIG. 2A with the first angle θ being 90 degrees. Referring to FIG. 4, which is a graph of the light collection efficiency of the light collection module in FIG. 2A having a first angle being 90 degrees regarding rays in different incident directions. The horizontal axis indicates different incident tilt angles β, and the vertical axis indicates the light collection efficiency. A thick solid line C11 is a curve corresponding to the horizontal incident angle α being 0 degrees. A thin solid line C13 is a curve corresponding to the horizontal incident angle α being 90 degrees. A dashed line C12 is a curve corresponding to the horizontal incident angle α being 45 degrees.

It can be seen from FIG. 4 that when the horizontal incident angle α of the rays 70 on the light collector 200 is 45 degrees, the light collector 200 has a good light collection efficiency, and the highest light collection efficiency reaches 43%. The light collection efficiency is a ratio of light intensity I₁ of the rays 70 incidenting to the first surface 50 to light intensity I₂ of the rays 70 exiting from the first surface 50, that is, I₂/I₁.

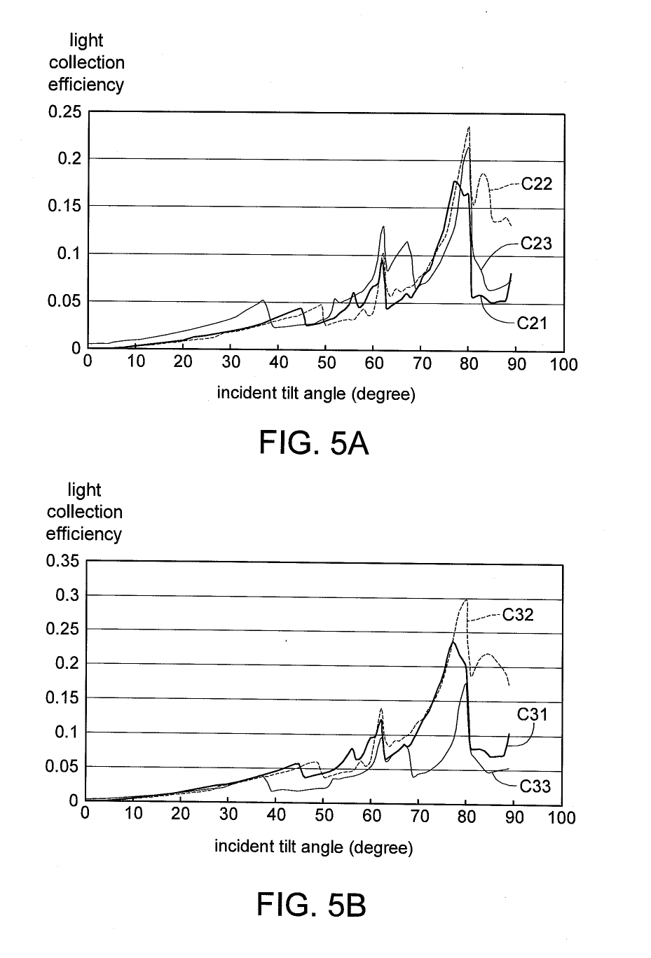

Referring to FIGS. 5A and 5B, FIG. 5A is a graph of the light collection efficiency of the light collection module in FIG. 2A regarding a horizontal incident angle of rays being 0 degree when second angles between a lit surface and a normal line are 0 degrees, 5 degrees, and 40 degrees, and a third angle between a non-lit surface and the normal line is 80 degrees. FIG. 5B is a graph of the light collection efficiency of the light collection module in FIG. 2A regarding a horizontal incident angle of rays being 90 degrees when second angles between a lit surface and a normal line are 0 degrees, 5 degrees, and 40 degrees, and a third angle between a non-lit surface and the normal line is 80 degrees. The first angle θ is 30 degrees. The horizontal axis indicates different incident tilt angles β, and the vertical axis indicates the light collection efficiency. Thick solid lines C21 and C31 are curves corresponding to the second angle γ between the lit surface 62 and the normal line 26 being 0 degrees, respectively. Dashed lines C22 and C32 are curves corresponding to the second angle γ between the lit surface 62 and the normal line 26 being 5 degrees. Thin solid lines C23 and C33 are curves corresponding to the second angle γ between the lit surface 62 and the normal line 26 being 40 degrees.

It can be seen from FIG. 5A and FIG. 5B that when the rays 70 are incident on the light collector 200, in which the second angle γ between the lit surface 62 and the normal line 26 is 5 degrees and the third angle δ between the non-lit surface 64 and the normal line 26 is 80 degrees, the light collector 200 has a good light collection efficiency, and the highest light collection efficiency reaches 30%.

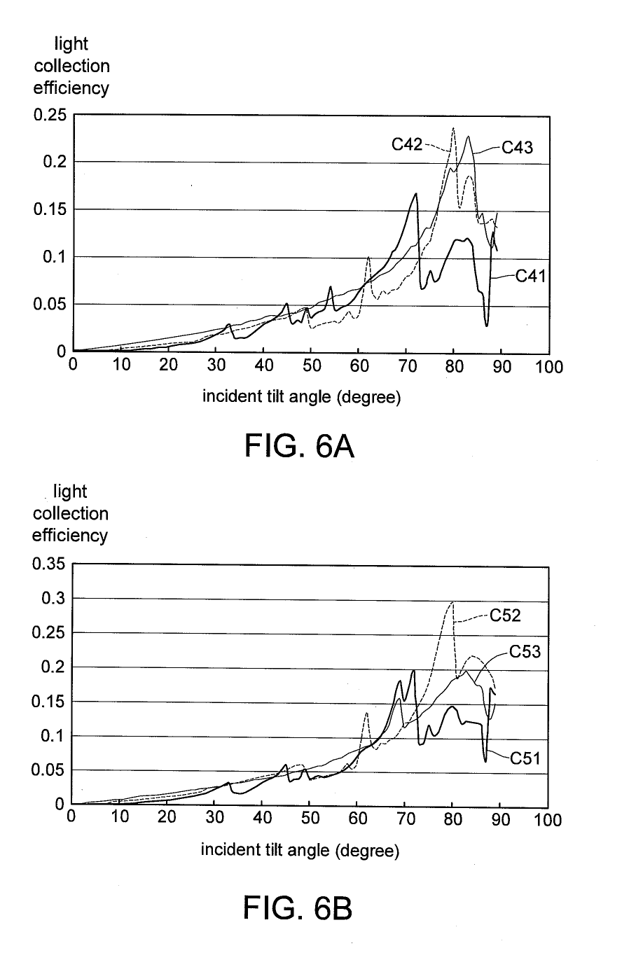

Referring to FIG. 6A and FIG. 6B, FIG. 6A is a graph of the light collection efficiency of the light collection module in FIG. 2A regarding a horizontal incident angle of rays being 0 degree when third angles between a non-lit surface and a normal line are 70 degrees, 80 degrees, and 89 degrees, and a second angle between a lit surface and the normal line is 5 degrees. FIG. 6B is a graph of the light collection efficiency of the light collection module in FIG. 2A regarding a horizontal incident angle of rays being 90 degrees when third angles between a non-lit surface and a normal line are 70 degrees, 80 degrees, and 89 degrees, and a second angle between a lit surface and the normal line is 5 degrees. The first angle θ is 30 degrees. The horizontal axis indicates different incident tilt angles β, and the vertical axis indicates the light collection efficiency. Thick solid lines C41 and C51 are curves corresponding to the third angle δ between the non-lit surface 64 and the normal line 26 being 70 degrees. The dashed lines C42 and C52 are curves corresponding to the third angle δ between the non-lit surface 64 and the normal line 26 being 80 degrees. The thin solid lines C43 and C53 are curves corresponding to the third angle 8 between the non-lit surface 64 and the normal line 26 being 89 degrees.

It can be seen from FIGS. 6A and 6B that when the rays 70 are incident on the light collector 200, in which the third angle δ between the non-lit surface 64 and the normal line 26 is 80 degrees and the second angle γ between the lit surface 62 and the normal 26 is 5 degrees, the light collector 200 has a good light collection efficiency, and the highest light collection efficiency reaches 30%.

Furthermore, in some other embodiments, the light collector 200 does not comprise the reflective surface 75, and a refractive index of the light collector 200 and a refractive index of an external environment are adjusted to make the rays 70, received by the microstructures 60, undergo total reflection at an interface between the light collector 200 and the external environment.

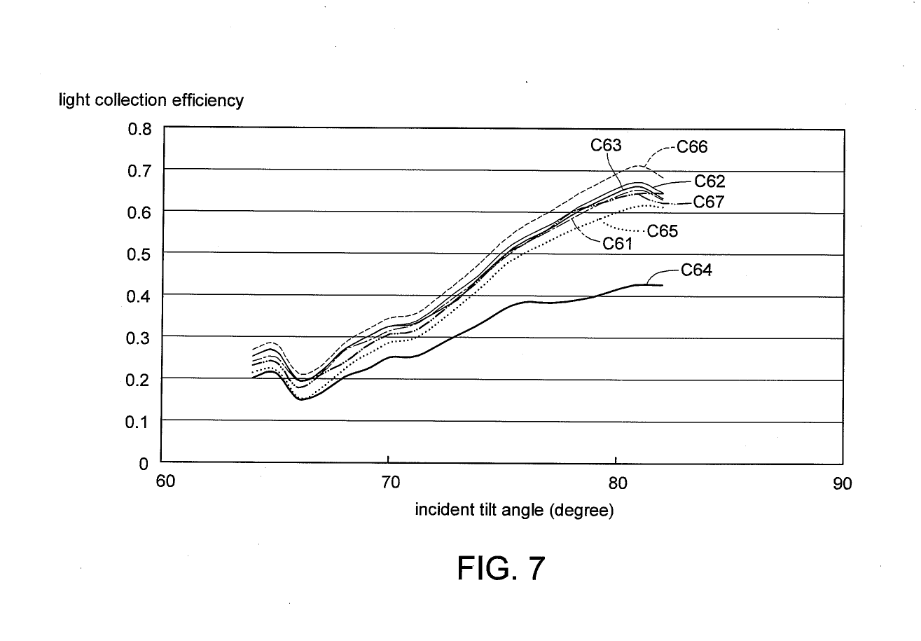

Referring to FIG. 7, which is a graph of the light collection efficiency of the single-dimensional light collection module in FIG. 2A in which a light emitting surface and a first surface form different first angles. The single dimension indicates the microstructures 60 distributed on the first surface 50 are not symmetrically arranged along the central axis, and therefore the lit surfaces 62 and the non-lit surfaces 64 face towards the same direction. The horizontal axis indicates different incident tilt angles β, and the vertical axis indicates the light collection efficiency. A curve line C61 is a light collection efficiency curve corresponding to the first angle θ being 10 degrees. A curve line C62 is a light collection efficiency curve corresponding to the first angle θ being 25 degrees. A curve line C63 is a light collection efficiency curve corresponding to the first angle θ being 35 degrees. A curve line C64 is a light collection efficiency curve corresponding to the first angle θ being 55 degrees. A curve line C65 is a light collection efficiency curve corresponding to the first angle θ being 75 degrees. A curve line C66 is a light collection efficiency curve corresponding to the first angle θ being 85 degrees. A curve line C67 is a light collection efficiency curve corresponding to included angles between the light emitting surfaces 41, 42, 43, and 44 and the first surface 50 being 25 degrees.

It can be seen from FIG. 7 that when 10°≦θ≦35° or 85°≦θ<90°, the rays 70 that undergo total reflection at the light emitting surfaces 41, 42, 43, and 44 (that is, the interface between the light collector 200 and the external environment) are reduced, so that the light collector 200 has a good light collection efficiency, and the highest light collection efficiency reaches 71%.

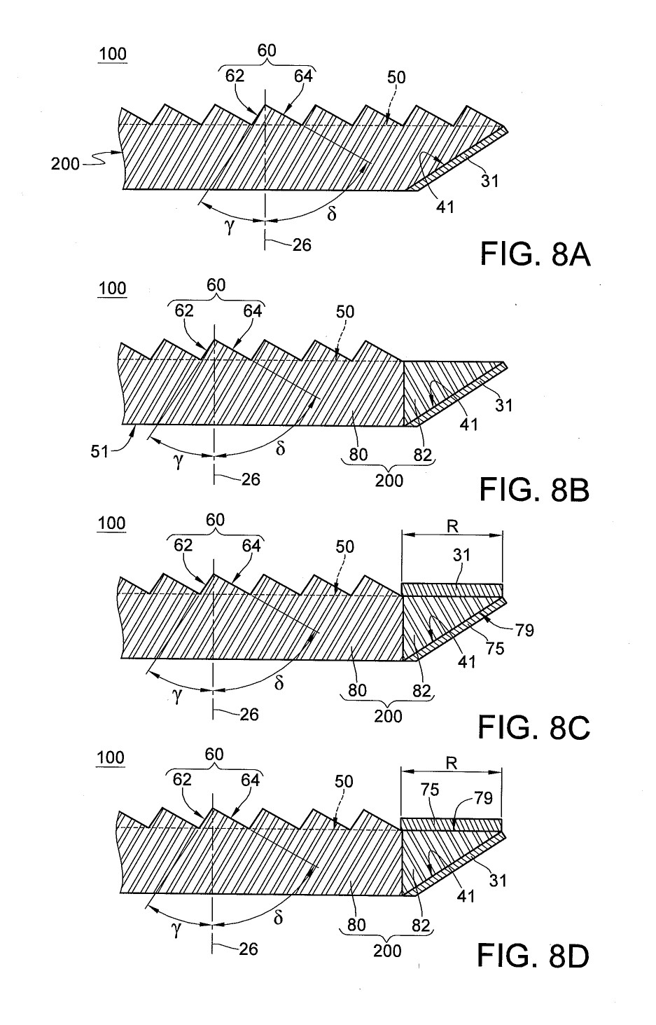

In an embodiment, the light collector 200 is an integrally formed transparent optical film, as shown in FIGS. 2A, 2B, and 8A but not limited to the disclosure. FIG. 8A is a schematic sectional view of the light collection module in FIG. 1A according to an embodiment of the disclosure. Compared to the light collector 200 in FIGS. 2A and 2B, the light collector 200 in FIG. 8A does not comprise the reflective surface 79 and the reflective surface 75.

In another embodiment, the light collector 200 is a transparent optical film but not integrally formed, as shown in FIG. 8B, which is a schematic sectional view of the light collection module in FIG. 1A according to an embodiment of the disclosure. The light collector 200 further comprises a light collection unit 80 and a wedge-shaped unit 82. The light collection unit 80 is arranged between the first surface 50 and the second surface 51. The wedge-shaped unit 82, arranged on the periphery of the light collection unit 80, has the light emitting surfaces 41, 42, 43, and 44. The energy conversion materials 31 are arranged on the light emitting surfaces 41, 42, 43, and 44 of the light collector 200.

In this and some other embodiments, the wedge-shaped unit 82 further has the reflective surface 75. The reflective surface 75 is arranged on the light emitting surfaces 41, 42, 43, and 44 or the edge region R of the first surface 50, so as to reflect the rays 70 received by the microstructures 60, as shown in FIGS. 8C and 8D. FIG. 8C is a schematic sectional view of the light collection module in FIG. 1A according to an embodiment of the disclosure. FIG. 8D is a schematic sectional view of the light collection module in FIG. 1A according to an embodiment of the disclosure. In this embodiment, the energy conversion materials 31 are arranged on the edge region R on the first surface 50 of the light collector 200 or the light emitting surfaces 41, 42, 43, and 44.

In this and some other embodiments, the light collector 200 is a symmetrical optical film (the first surface 50 has the symmetry axis 24). Therefore, only one side of the light collector 200 is illustrated in FIG. 8A, FIG. 8B, FIG. 8C, and FIG. 8D.

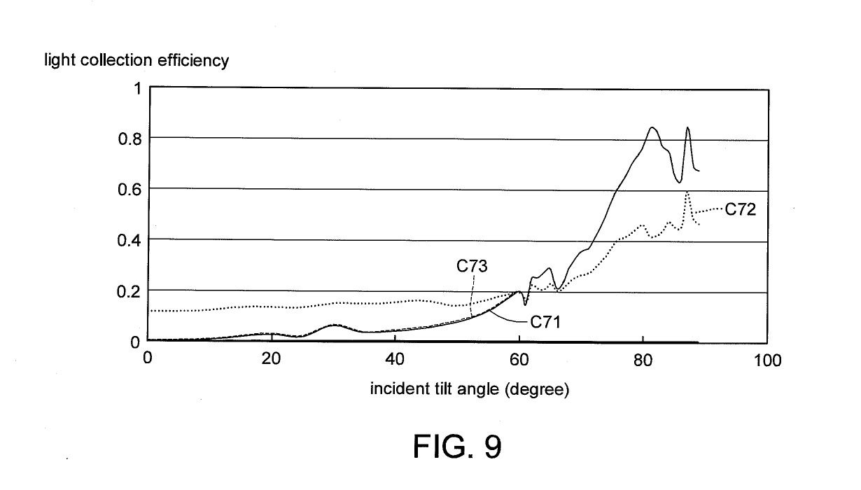

On the other hand, under the circumstances that the first angle is 85 degrees, the light collection efficiencies of the single-dimensional light collection units in FIGS. 8A, 8B and 8D are shown in FIG. 9. The horizontal axis indicates different incident tilt angles β, and the vertical axis indicates the light collection efficiency. A curve line C71 applies a curve line of the single-dimensional light collection units in FIG. 8B. A curve line C72 applies a curve line of the single-dimensional light collection units in FIG. 8A. A curve line C73 applies a curve line of the single-dimensional light collection units in FIG. 8D.

It can be seen form the FIG. 9 that by adjusting the incident tilt angles β to an appropriate angle, the light collection efficiency of the single-dimensional light collection unit may reach more than 80%.

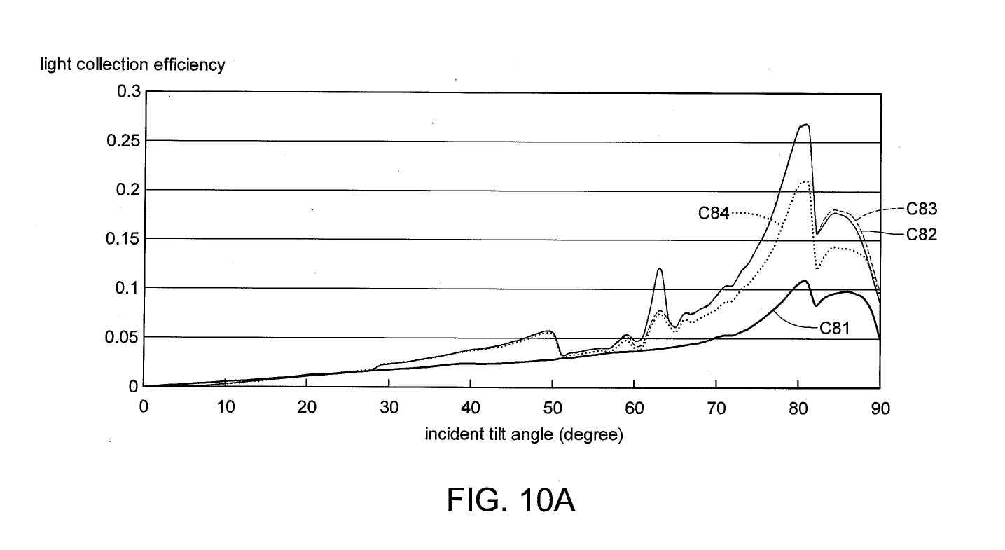

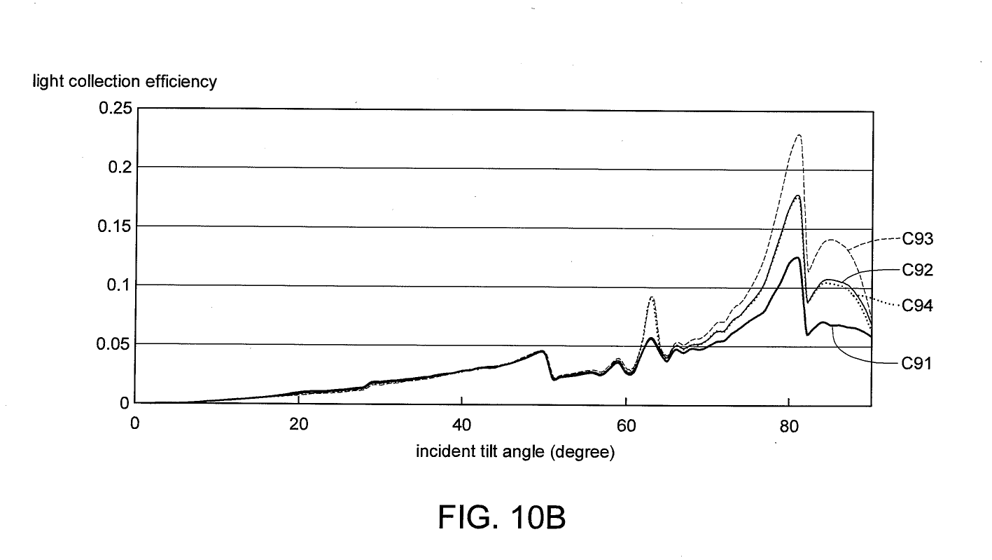

Referring to FIGS. 10A and 10B, FIG. 10A is a graph of the light collection efficiency regarding different proportions of area of a first surface of the light collection module in FIG. 8D occupied by microstructures when a horizontal incident angle of rays being 0 degree. FIG. 10B is a graph of the light collection efficiency regarding different proportions of an area of a first surface of a light collector in FIG. 8D occupied by microstructures when a horizontal incident angle of rays being 90 degree. In FIG. 10A, the horizontal incident angle α is 0 degree, and the incident tilt angle β ranges from 0 to 90 degrees. In FIG. 10B, the horizontal incident angle α is 90 degrees, and the incident tilt angle β ranges from 0 to 90 degrees.

Curves C81 and C91 represent the light collection efficiencies when the areas of the microstructures 60 account for 25% of the areas of the first surfaces 50. The 25% of the area indicates that the microstructures 60 are arranged on only one of the four light collection regions. Curves C82 and C92 represent the light collection efficiencies when the areas of the microstructures account for 50% of the areas of the first surfaces 50. The 50% of the area indicates that the microstructures 60 are arranged on only two of the four light collection regions. Curves C83 and C93 represent the light collection efficiencies when the areas of the microstructures 60 account for 75% of the areas of the first surfaces 50. The 75% of the area indicates that the microstructures 60 are arranged on three of the four light collection regions. Curve C84 and C94 represent the light collection efficiencies when the areas of the microstructures 60 account for 100% of the areas of the first surfaces 50. The 100% of the area indicates that the microstructures 60 are arranged on each of the light collection regions.

It can be seen from FIG. 10A that, when the area occupied (namely, distributed) by the microstructures 60 is greater than 25%, the light collection efficiency is obviously increased when the incident tilt angle β is greater than 65 degrees. When the occupied (namely, distributed) area is greater than 75%, the light collection efficiency is greater than 20%.

Referring to FIG. 10B, when the area occupied by the microstructures 60 is greater than 25%, the light collection efficiency is obviously increased when the incident tilt angle 13 is greater than 65 degrees. When the occupied area is greater than 75%, the light collection efficiency is greater than 17%.

In all of the aforementioned embodiments, the lit surface 62 of each microstructure 60 is designed to face the central axis 22, so as to transmit the rays 70 received by the light collector 200 to the light emitting surfaces 41, 42, 43, and 44 which surround the first surface 50, but the aforementioned embodiments are not intended to limit the disclosure.

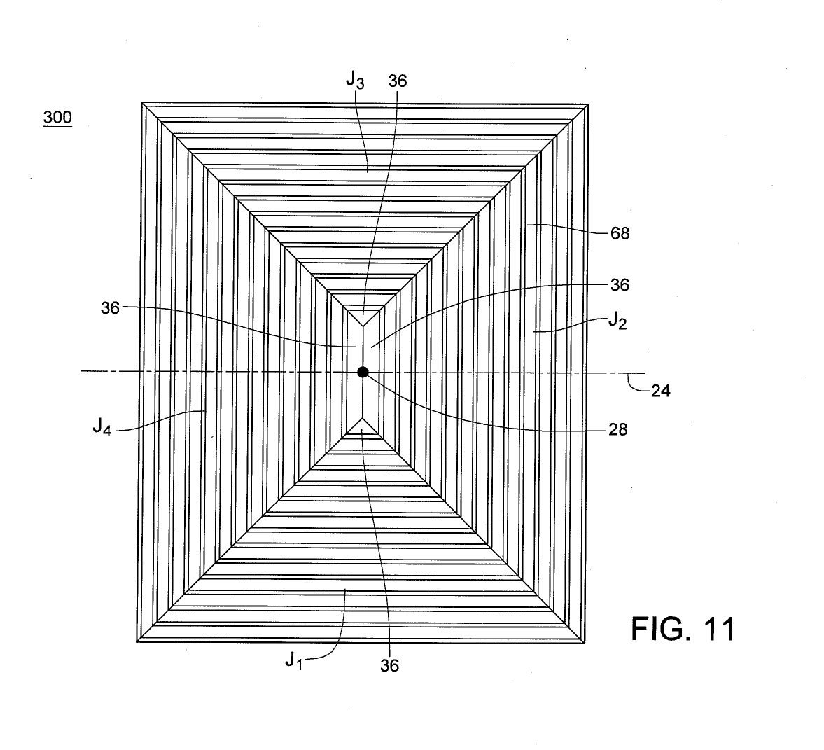

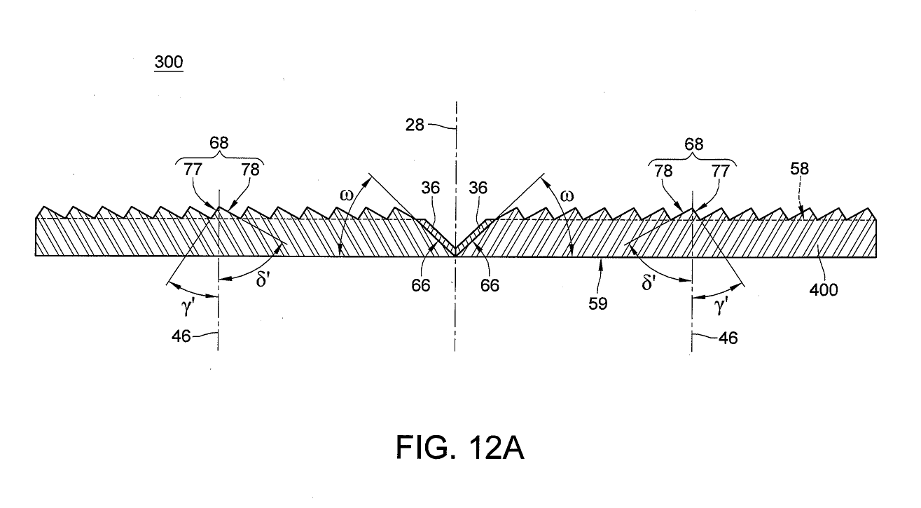

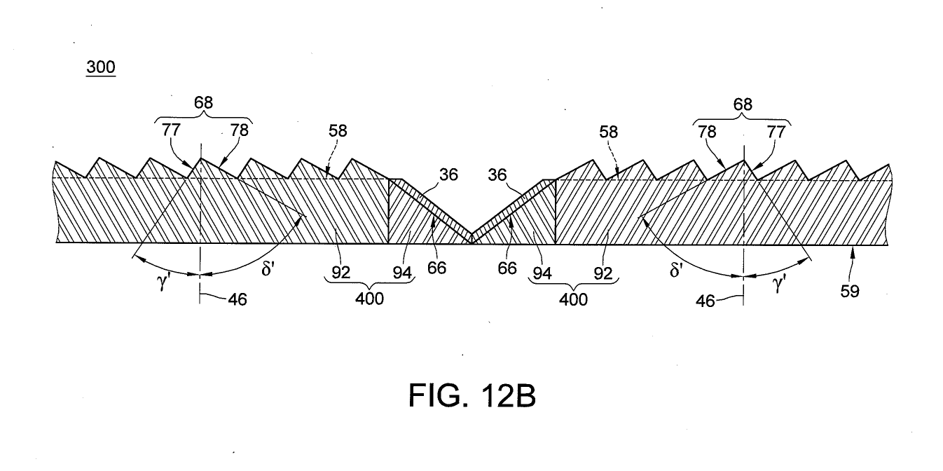

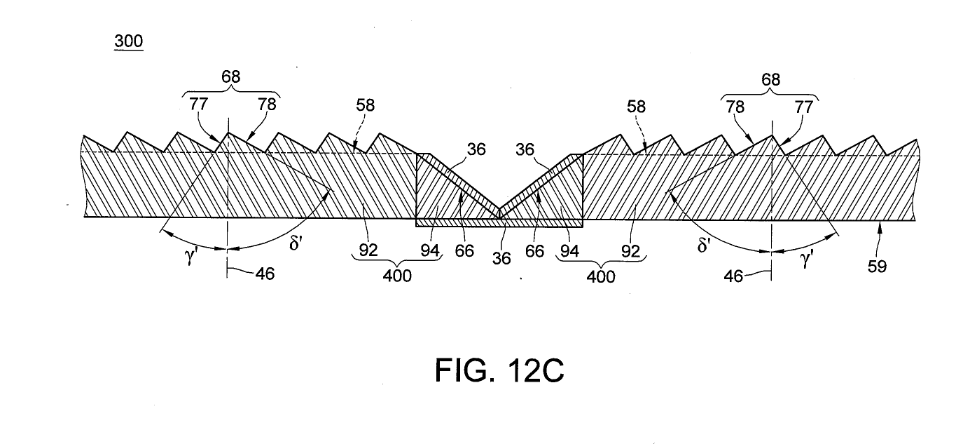

For example, referring to FIG. 11 and FIG. 12A, FIG. 11 is a schematic structural top view of a light collection module according to a second embodiment of the disclosure, and FIG. 12A is a schematic sectional view of the light collection module in FIG. 11 according to an embodiment of the disclosure. In this embodiment, a light collection module 300 comprises a light collector 400 and a plurality of energy conversion materials 36. The light collector 400 comprises a plurality of light emitting surfaces 66, and a first surface 58 and a second surface 59. The first surface 58 and the second surface 59 are opposite to each other.

For example, the periphery of the light collector 400 is a quadrangle. In this and some other embodiments, the number of the energy conversion materials 36 is four, and the number of the light emitting surfaces 66 is four. The four light emitting surfaces 66 are adjacent to the first surface 58 and the second surface 59 respectively. In this and some other embodiments, the four light emitting surfaces 66 each form a first included angle ω with the second surface 59. In this and some other embodiments, the first included angle ω satisfies the following conditions:

10°≦ω≦35°; or

85°≦ω<90°.

In this and some other embodiments, the material of the light collector 400 is Polymethylmethacrylate (PMMA), but not limited to the disclosure.

The first surface 58 has a plurality of microstructures 68. Each microstructure 68 is used for receiving rays 70 of different incident directions, and transmitting the rays 70 to the four light emitting surfaces 66. In this and some other embodiments, the four energy conversion materials 36 are arranged on the light emitting surfaces 66 respectively, so as to convert the rays 70 from the light collector 400 into electric energy.

In this and some other embodiments, each microstructure 68 comprises a lit surface 77 and a non-lit surface 78. The lit surface 77 and a normal line 46 of the first surface 58 form a second angle γ′, the first non-lit surface 78 and the normal line 46 form a third angle δ′, and the following conditions are satisfied:

0°≦γ′≦40°; and

70°≦δ′<90°.

Each non-lit surface 78 faces a central axis 28 of the first surface 58. Therefore, after being emitted to the first surface 58, the rays 70 are continuously transmitted to the four light emitting surfaces 66 adjacent to the first surface 58. The central axis 28, located at a geometric center of the first surface 58, is perpendicular to the first surface 58.

In this and some other embodiments, the light collector 400 is an integrally formed transparent optical film, but not limited to the disclosure. In this and some other embodiments, the light collector 400 is a transparent optical film but not integrally formed, as shown in FIG. 12B, which is a schematic sectional view of the light collection module in FIG. 11 according to an embodiment of the disclosure. The light collector 400 comprises a light collection unit 92 and a wedge-shaped unit 94. The light collection unit 92 is arranged between the first surface 58 and the second surface 59. The wedge-shaped unit 94 is arranged on the geometric center of the light collection unit 92. The wedge-shaped unit 94 has the four light emitting surfaces 66, and the energy conversion materials 36 are respectively arranged on the light emitting surfaces 66 of the light collector 400.

The light collector 400 further comprises another energy conversion material 36 arranged on the wedge-shaped unit 94 in an end of the second surface 59, as shown in FIG. 12C, which is a schematic sectional view of the light collection module in FIG. 11 according to an embodiment of the disclosure.

In the light collector and the light collection module according to the embodiments of the disclosure, the first surface, which has the microstructures in different arrangement directions, is used for receiving rays of different incident directions, so as to solve problems of the conventional solar cell system such as the decrease in the power generation amount incurred by the fixed angle of ray reception, the high cost incurred by the mounting of a sensor, and the difficulty in mounting due to the large volume. Furthermore, by designing the first included angle ω formed by the first surface and the light emitting surface or the first angle θ formed by the second surface and the light emitting surface, the lost of a part of the rays are avoided because of the total reflection at the interface between the light emitting surface and the external environment, so as to improve the light collection efficiency of the light collector, thereby improving conversion efficiency of the energy conversion material. When satisfying 10°≦θ (or ω)≦35° or 85°≦θ (or ω)<90°, the light collection efficiency of the light collector is improved.

Furthermore, the light collector is, for example, a transparent optical film, which is a screen protection film applicable to electronic devices such as a mobile phone or a notebook computer. Therefore on one hand, the display screen is prevented from being worn, on the other hand, rays from an external environment are transmitted to the light emitting surface, so that an electric energy conversion element arranged on the light emitting surface outputs electric energy to charge a battery of the electronic device.

What is claimed is:

1. A light collector, comprising:
a first surface having a plurality of microstructures, and the plurality of microstructures being used for receiving a ray;
a second surface opposite to the first surface; and
at least one light emitting surface, adjacent to the first surface and the second surface, and the at least one light emitting surface forming a first angle θ with the first surface or the second surface, so as to output the ray received by the plurality of microstructures;
wherein the light collector satisfies 10°≦θ≦35° or 85°≦θ<90°.

2. The light collector according to claim 1, wherein each of the plurality of microstructures comprises a lit surface and a non-lit surface, a second angle between the lit surface and a normal line of the first surface is γ, a third angle between the non-lit surface and the normal line of the first surface is δ, and the light collector satisfies 0°≦γ≦40°, and 70°≦δ<90°.

3. The light collector according to claim 2, wherein the first surface further has a central axis, and the lit surfaces face the central axis.

4. The light collector according to claim 2, wherein the first surface further has a central axis, and the non-lit surfaces face the central axis.

5. The light collector according to claim 1, wherein the light collector further has a reflective surface, the reflective surface is arranged on an edge region of the first surface or on the at least one light emitting surface.

6. The light collector according to claim 1, further comprising:
a light collection unit arranged between the first surface and the second surface; and
a wedge-shaped unit arranged on the periphery or the geometric center of the light collection unit, and the wedge-shaped unit having the at least one light emitting surface.

7. The light collector according to claim 6, wherein the wedge-shaped unit further has a reflective surface arranged on an edge region of the first surface or on the at least one light emitting surface.

8. The light collector according to claim 1, wherein the first surface further has at least one symmetry axis, and the plurality of microstructures are symmetrically arranged on the first surface according to the at least one symmetry axis.

9. The light collector according to claim 1, wherein the light emitting surface is in the shape of an annular band.

10. The light collector according to claim 1, wherein each of the plurality of microstructures is a bent stripe-shaped structure, an arc stripe-shaped structure or a striped structure including an arc line and a straight line.

11. The light collector according to claim 10, wherein the radii of curvature of the two of the plurality of microstructures adjacent to each other are the same or different.

12. The light collector according to claim 1, wherein each of the plurality of microstructures comprises a plurality of segments discontinuously arranged, and the plurality of segments are arranged into a broken-line structure, an arc-line structure or a curve-line structure including an arc line and a straight line.

13. The light collector according to claim 12, wherein the radii of curvature of the two of the plurality of microstructures adjacent to each other are the same or different.

14. A light collection module, comprising:
a light collector, comprising:
a first surface having a plurality of microstructures, and the plurality of microstructures being used for receiving a ray;
a second surface opposite to the first surface; and
at least one light emitting surface adjacent to the first surface and the second surface, the at least one light emitting surface forming a first angle θ with the first surface or the second surface, and the light collection module satisfying 10°≦θ≦35° or 85°≦θ<90°; and
at least one energy conversion material arranged on the light collector, and the at least one energy conversion material being used for converting the ray from the light collector into electric energy.

15. The light collection module according to claim 14, wherein each of the microstructures comprises a lit surface and a non-lit surface, a second angle between the lit surface and a normal line of the first surface is γ, a third angle between the non-lit surface and the normal line of the first surface is δ, and the light collection module satisfies 0°≦γ≦40°, and 70°≦δ<90°.

16. The light collection module according to claim 15, wherein the first surface further has a central axis, and the lit surfaces face the central axis.

17. The light collection module according to claim 15, wherein the first surface further has a central axis, and the non-lit surfaces face the central axis.

18. The light collection module according to claim 14, wherein the light collector further has a reflective surface arranged on an edge region of the first surface, and the at least one energy conversion material is arranged on the at least one light emitting surface.

19. The light collection module according to claim 14, wherein the light collector further has a reflective surface arranged on the at least one light emitting surface, and the at least one energy conversion material is arranged on an edge region of the first surface.

20. The light collection module according to claim 14, wherein the light collector further comprises:
a light collection unit arranged between the first surface and the second surface; and
a wedge-shaped unit arranged on the periphery or the geometric center of the light collection unit, and the wedge-shaped unit having the at least one light emitting surface.

21. The light collection module according to claim 20, wherein the wedge-shaped unit further has a reflective surface arranged on an edge region of the first surface, and the at least one energy conversion material is arranged on the at least one light emitting surface.

22. The light collection module according to claim 20, wherein the wedge-shaped unit further has a reflective surface arranged on the at least one light emitting surface, and the at least one energy conversion material is arranged on at least one of an edge region of the first surface and an end of the wedge-shaped unit arranged on the second surface.

23. The light collection module according to claim 14, wherein the first surface further has at least one symmetry axis, and the plurality of microstructures are symmetrically arranged on the first surface according to the at least one symmetry axis.
